(19) United States
(12) Patent Application Publication
(10) Pub. No.: US 2011/0242469 A1
(43) Pub. Date: Oct. 6, 2011

(54) LIQUID CRYSTAL DISPLAY DEVICE

(75) Inventors: Tetsuya KAWAMURA, Saitama-ken (JP); Yukio TANAKA, Ishikawa-ken (JP); Toshiyuki HIGANO, Ishikawa-ken (JP); Kazuyuki HARADA, Ishikawa-ken (JP); Atsushi MIZUYOSHI, Ishikawa-ken (JP); Yasuhiro YAMAMOTO, Ishikawa-ken (JP); Junichi KOBAYASHI, Ishikawa-ken (JP)

(73) Assignee: Toshiba Mobile Display Co., Ltd., Fukaya-shi (JP)

(21) Appl. No.: 13/077,284

(22) Filed: Mar. 31, 2011

(30) Foreign Application Priority Data
Mar. 31, 2010 (JP) 2010-084065

(51) Int. Cl. G02F 1/1333

(52) U.S. Cl. 349/138

(57) ABSTRACT

In one embodiment, a liquid crystal display device includes a first substrate, a second substrate and a liquid crystal layer held between the first and second substrates. The first substrate includes a first insulating substrate, and a pixel electrode and a counter electrode formed on the first insulating substrate. The second substrate includes a second insulating substrate. A first light shield layer is formed on a surface of the second insulating substrate apart from an end of the second insulating substrate opposing to the first substrate, and having a frame portion in a frame shape. Furthermore, a second light shield layer is arranged adjoining the first light shield layer extending up to the end of the second insulating substrate opposing to the first substrate. A third light shield layer to shield light is provided between the first light shield layer and second light shield layer.

### CROSS-REFERENCE TO RELATED APPLICATION

This application is based upon and claims the benefit of priority from Japanese Patent Application No. P2010-84065, filed Mar. 31, 2010, the entire contents of which are incorporated herein by reference.

### FIELD

Embodiments described herein relate generally to a liquid crystal display device.

### BACKGROUND

In recent years, a flat display is actively developed, and especially a liquid crystal display device is applied to various fields by employing advantages, such as lightness, compactness and low power consumption. Especially, the liquid crystal display device using lateral electric field modes, such as IPS (In-Plane Switching) mode and FFS (Fringe-Field Switching) mode excels in a viewing angle characteristic. There is little feeling of strangeness due to change of image quality when the display device is tilted from the front. Accordingly, the liquid crystal display devices using lateral electric field modes are increasingly used by many portable devices.

For example, Japanese laid open patent application No. 2009-8971 discloses an electro-optical device using the lateral electric field mode. The device includes a first substrate in which a common electrode, a pixel electrode and an electrode for grounding are formed. The device further includes a second substrate in which an electric conductive layer is formed on a surface opposite the first substrate and includes a through hole penetrating from the surface of the electric conductive layer side to the surface of the first substrate side. Electro-optical material is held between the first and second substrates. The electric conductive layer is electrically connected with the electrode for grounding through an electric conductive element, etc., arranged in the through hole.

On the other hand, in the liquid crystal display device using the lateral electric field modes, such as IPS mode and FFS mode, a counter substrate is not equipped with an electrode while an array substrate includes an electrode to form the lateral electric field. For this reason, there is a possibility of having a bad influence on display quality, such as generation of luminosity unevenness and an increase in a flicker by electric charges flowing into the inside of a liquid crystal display panel from the exterior or electric charges generated by drive operation. In order to control such phenomenon, a structure to provide a shield electrode between the counter substrate and a polarizing plate is frequently adopted.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a view schematically showing a liquid crystal display device according to an embodiment.

FIG. 2 is a view showing a structure and an equivalent circuit of a liquid crystal display panel shown in FIG. 1.

FIG. 3 is a plan view schematically showing a structure of a pixel in an array substrate shown in FIG. 2 looking from a counter substrate side.

FIG. 4 is a cross-sectional view schematically showing a structure of the pixel in the liquid crystal panel shown in FIG. 3 taken along line A-B.

FIG. 5 is a cross-sectional view schematically showing a structure of the pixel in the liquid crystal panel shown in FIG. 3 taken along line C-D.

FIG. 6 is a view schematically showing a main portion of a liquid crystal display panel LPN1 in which a first light shield layer does not extend up to an end of the substrate and a main portion of a liquid crystal display panel LPN2 in which the first light shield layer extends up to the end of the substrate.

FIG. 7 is a plan view schematically showing a liquid crystal display panel according to the embodiment looking from the counter substrate.

FIG. 8 is a plan view schematically showing an example of a first light shield layer and a second light shield layer applicable to the liquid crystal display panel shown in FIG. 7.

FIG. 9 is a cross-sectional view schematically showing the liquid crystal display panel shown in FIG. 7 taken along line E-F

FIG. 10 is a view showing an example of measured result about a flicker in the liquid crystal display panel LPN2 shown in FIG. 6 and the liquid crystal display panel LPN according to the embodiment.

FIG. 11 is an enlarged view schematically showing a structure of a region P in the liquid crystal display panel shown in FIG. 9.

FIG. 12 is an enlarged view schematically showing another structure of the region P in the liquid crystal display panel shown in FIG. 9.

FIG. 13 is a plan view schematically showing an arrangement example of a third light shield layer facing a slit.

FIG. 14 is a cross-sectional view schematically showing other structure of the liquid crystal display panel shown in FIG. 7 taken along line E-F.

FIG. 15 is a cross-sectional view schematically showing other structure of the liquid crystal display panel shown in FIG. 7 taken along line E-F.

FIG. 16 is a cross-sectional view schematically showing an example of a structure to set the first light shield layer to a fixed potential.

FIG. 17 is a plan view showing other example of the first light shield layer and the second light shield layer applicable to the liquid crystal display panel shown in FIG. 7.

FIG. 18 is a view to explain a write-in operation of images in an image display mode.

FIG. 19 is a view to explain a write-in operation of a detection signal and a detection operation in a detection mode.

### DETAILED DESCRIPTION OF THE INVENTION

A liquid crystal display device according to an exemplary embodiment of the present invention will now be described with reference to the accompanying drawings wherein the same or like reference numerals designate the same or corresponding portions throughout the several views.

According to one embodiment, a liquid crystal display device includes: a first substrate including a first insulating substrate, and a pixel electrode and a counter electrode formed on the first insulating substrate; a second substrate including a second insulating substrate, a first light shield layer formed on a surface of the second insulating substrate apart from an end of the second insulating substrate opposing to the first substrate and having a frame portion in a frame shape, and a second light shield layer arranged adjoining the first light shield layer and extending up to the end of the second insulating substrate opposing to the first substrate; a liquid crystal layer held between the first and second substrates; and a third light shield layer to shield light between the first light shield layer and second light shield layer.

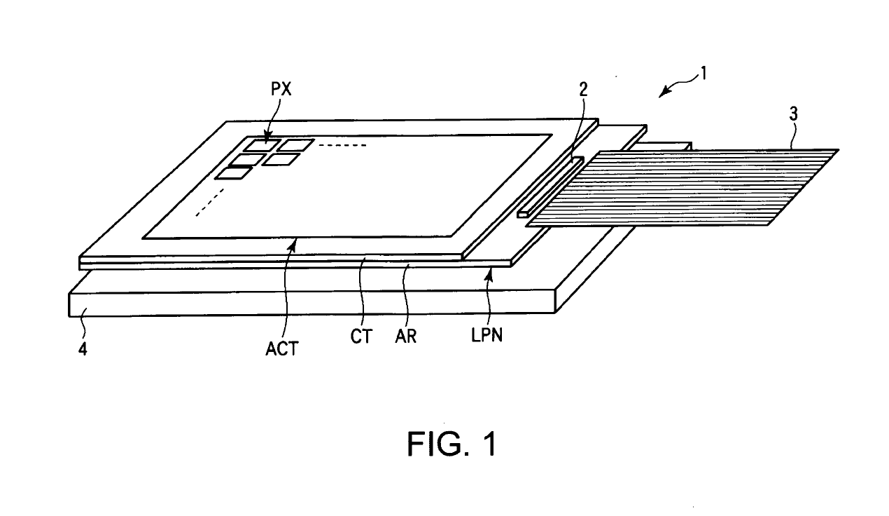

Hereafter, one embodiment is explained in detail, referring to drawings. FIG. 1 is a view schematically showing a liquid crystal display device according to an embodiment.

That is, the liquid crystal display device 1 is equipped with a liquid crystal display panel LPN of an active-matrix type, a driving IC chip 2 connected to the liquid crystal display panel LPN, a flexible wiring substrate 3 and a back light 4 to illuminate the liquid crystal display panel LPN.

The liquid crystal display panel LPN includes an array substrate AR as a first substrate, a counter substrate CT as a second substrate arranged so as to oppose to the array substrate AR and a liquid crystal layer (which is not shown) held between the array substrate AR and the counter substrate CT. Such liquid crystal display panel LPN includes an active area ACT to display an image. The active area ACT is configured by a plurality of pixels PX arranged in the shape of an (m×n) matrix (here, “m” and “n” are positive integers).

The back light 4 is arranged at the back side of the array substrate AR in the illustrated example. Various forms can be applied as the back light 4, and a light emitting diode (LED) and a cold cathode pipe (CCFL), etc., are used as a light source, and explanation is omitted about the detailed structure.

In the liquid crystal display 1 according to this embodiment, a display surface is formed in a counter substrate CT side in the liquid crystal display 1. Moreover, in a type containing a touch-panel function in the inside of the liquid crystal display panel LPN, while the display surface is formed in the counter substrate CT side, the detection plane to detect contact by an object is also formed on the counter substrate CT side.

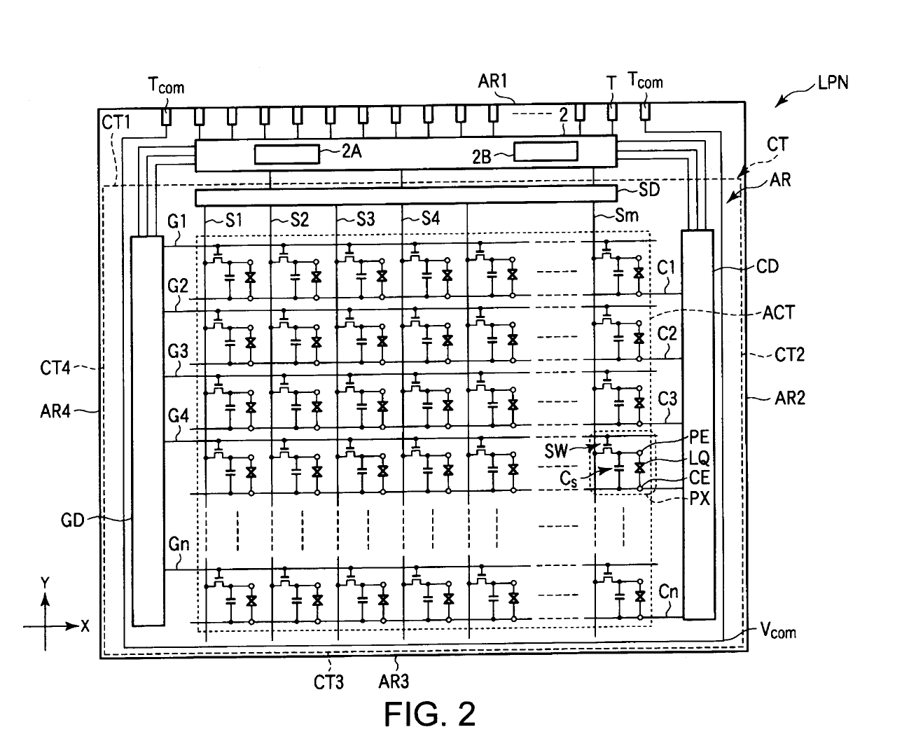

FIG. 2 is a view showing a structure and an equivalent circuit of a liquid crystal display panel LPN shown in FIG. 1.

The array substrate AR and the counter substrate CT are respectively formed approximately in a quadrangle shape, for example. The array substrate AR has a first side AR1, a second side AR2, a third side AR3, and a fourth side AR4. The counter substrate CT has a first side CT1, a second side CT2, a third side CT3, and a fourth side CT4. The second side CT2 of the counter substrate CT is located right above the second side AR2 of the array substrate AR. Similarly, The third side CT3 of the counter substrate CT is located right above the third side AR3 of the array substrate AR, and the fourth side CT4 of the counter substrate CT is located right above the fourth side AR4 of the array substrate AR. The first side CT1 of the counter substrate CT is located apart from the first side AR1 of the array substrate AR more closing to the active area ACT side.

The first side CT1, the second side CT2, the third side CT3, and the fourth side CT4 in the counter substrate CT correspond to substrate ends of the second insulating substrate which constitutes the counter substrate CT, which will be mentioned later.

In the active area ACT, the array substrate AR includes n gate lines G (G1-Gn) extending in a X direction respectively, n capacitance lines C (C1-Cn), m source lines S (S1-Sm) extending in a Y direction crossing the X direction respectively, (m×n) switching elements SW electrically connected with the gate line G and source line S in each pixel PX, (m×n) pixel electrodes PE electrically connected with the switching element SW in each pixel PX, and a counter electrode CE which is a portion of the capacitance line C and faces the pixel electrode PE. A retention voltage Cs is formed between the capacitance line C and the pixel electrode PE. The liquid crystal layer LQ is provided between the pixel electrode PE and the counter electrode CE.

Each gate line G is pulled out to the outside of the active area ACT and is connected to a first driver circuit GD. Each source line S is pulled out to the outside of the active area ACT and is connected to a second driver circuit SD. Each capacitance line C is pulled out to the outside of the active area ACT and is connected to a third drive circuit CD. At least one of the first driver circuit GD, source driver circuit SD and third driver circuit CD is formed in the array substrate AR and is electrically connected with the driving IC chip 2.

In the illustrated example, the driving IC chip 2 is mounted on the array substrate AR in the outside of the active area ACT. The driving IC chip 2 is located between the first side CT1 of the counter substrate CT and the first side AR1 of the array substrate AR. The illustration of a flexible wiring substrate is omitted. A terminal T for connecting the flexible wiring substrate is formed on the array substrate AR. The terminal T is arranged along with the first side AR1 of the array substrate AR. The common line Vcom for supplying common potential is connected to a common terminal Tcom among the terminals T. The common line Vcom passes along the outside of the first drive circuit GD and the third drive circuit CD, and is arranged along with the second side AR2, third side AR3 and fourth side AR4 of the array substrate AR.

The driving IC chip 2 includes an image signal write-in circuit 2A which performs a control required to write an image signal into the pixel electrode PE of each pixel PX in the image display mode to display images on the active area ACT. Moreover, in the type equipped with the touch panel function, the driving IC chip 2 is equipped with a detection circuit 2B to detect change of electric capacitance between the capacitance line C and source line S in the detection mode to detect objective contact on a detection plane, in addition to the image signal write-in circuit 2A. For details, it will be mentioned later.

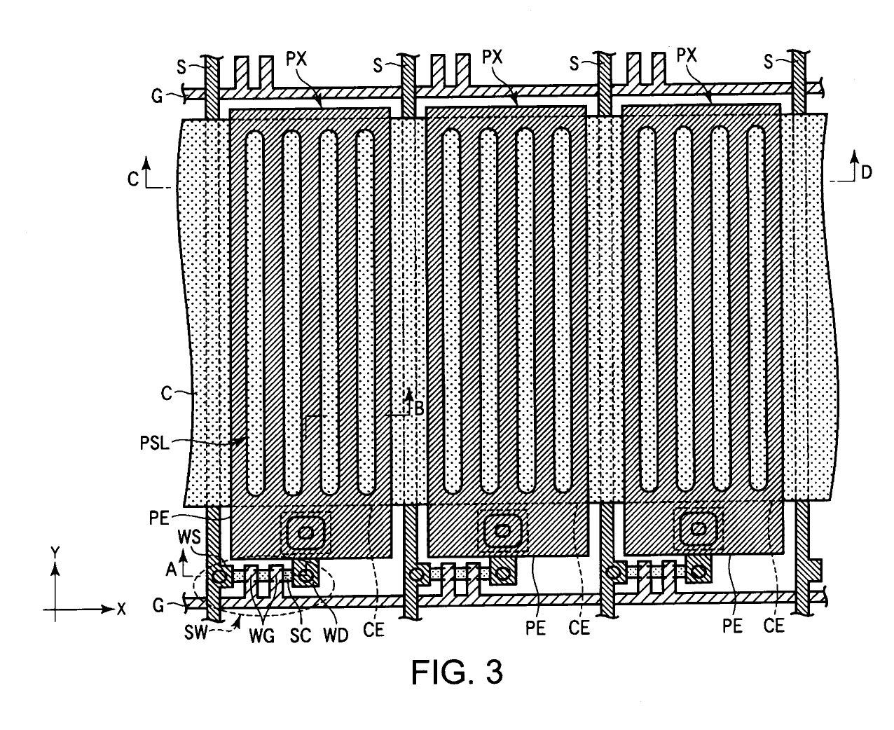

FIG. 3 is a plan view schematically showing a structure of the pixel in the array substrate shown in FIG. 2 looking from the counter substrate side. Here, a structure using FFS mode is explained. In the FFS mode, the array substrate AR includes a pixel electrode PE and a counter electrode CT, and liquid crystal molecule to constitute the liquid crystal layer is switched mainly using the lateral electric field (namely, electric field approximately parallel to the principal surface of the substrate).

Gate lines G extend in the X direction, respectively. Source lines S extend in the Y direction, respectively. Here, the Y direction intersects orthogonally with the X direction. The switching element SW is arranged near the intersection portion of the gate line G and source line S, for example, and is constituted by a thin film transistor (TFT). The switching element SW includes a semiconductor layer SC. The semiconductor layer SC can be formed by poly-silicon, amorphous silicon, etc. In this embodiment, poly-silicon is used, for example.

A gate electrode WG of the switching element SW is located right above the semiconductor layer SC and is electrically connected with the gate line G (in the illustrated example, the gate electrode WG is formed integrally with the gate line G). A source electrode WS of the switching element SW is electrically connected with the source line S (in the illustrated example, the source electrode WS is formed integrally with the source line 5). A drain electrode WD of the switching element SW is electrically connected with the pixel electrode PE.

The capacitance line C extends in the X direction, namely, the capacitance line C is arranged in each pixel PX and extends above the source line S by being connected in common to adjoining pixels PX in the X direction. The capacitance line C contains the counter electrode CE formed corresponding to each pixel PX. That is, the counter electrode CE corresponds to a portion of the capacitance line C facing the counter electrode CE. Respective counter electrodes CE are electrically connected above the source line S each other. In the illustrated example, the capacitance line C is formed in common to a plurality of pixel PXs arranged in one line in the X direction and is arranged between adjoining two gate lines G in the Y direction.

The pixel electrode PE of each pixel PX is arranged above the counter electrode CE. Each pixel electrode PE is formed in the shape of an island corresponding to the pixel shape, for example, an approximately quadrangle shape. The pixel electrodes PE are respectively connected with the drain electrode WD of the switching element SW. The slit PSL is formed in each pixel electrode PE. In the illustrated example, four slits PSL extend in the Y direction for each pixel electrode PE. Of course, the slits PSL are located above the counter electrode CE.

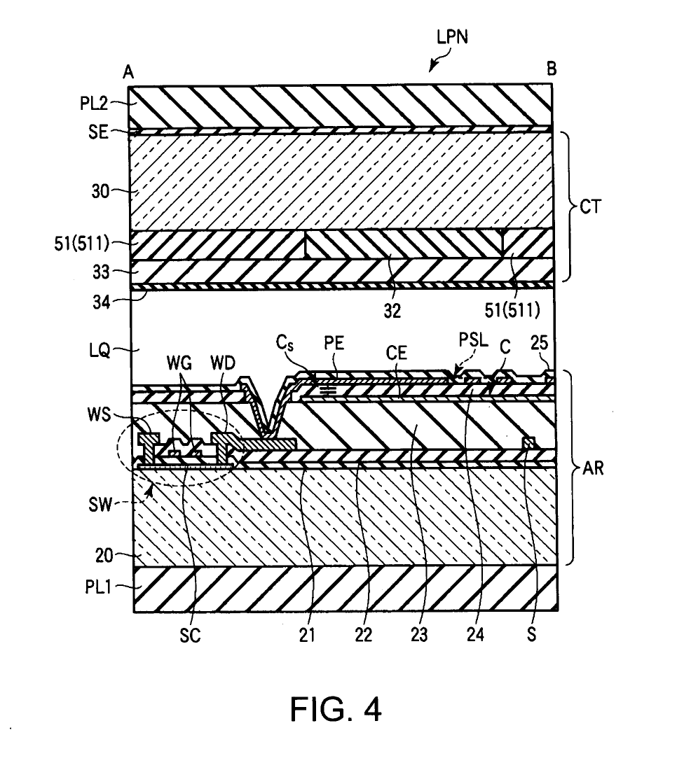

FIG. 4 is a cross-sectional view schematically showing a structure of the pixel in the liquid crystal panel shown in FIG. 3 taken along line A-B.

That is, the array substrate AR is formed using a first insulating substrate 20 with light transmissivity such as a glass substrate. The array substrate AR is equipped with the switching element SW, the capacitance line C which contains the counter electrode CE and the pixel electrode PE on the internal surface (namely, surface which counters the liquid crystal layer LQ) of the first insulating substrate 20. The switching element SW shown here is a thin film transistor of a top gate type.

The semiconductor layer SC is arranged on the first insulating substrate 20. The semiconductor layer SC is covered with a gate insulating film 21. Moreover, the gate insulating film 21 is arranged also on the first insulating substrate 20. In addition, although not illustrated, an under coat layer formed of an insulating film may be arranged between the first insulating substrate 20 and the semiconductor layer SC.

The gate electrode WG of the switching element SW is arranged on the gate insulating film 21 and is located right above the semiconductor layer SC. Although not illustrated, the gate line is also arranged on the gate insulating film 21 and is formed of the same material as the gate electrode WG. The gate electrode WG and gate line are covered with a first interlayer insulating film 22. Moreover, the first interlayer insulating film 22 is arranged also on the gate insulating film 21. The gate insulating film 21 and first interlayer insulating film 22 are formed of inorganic system materials, such as nitride silicon (SiN), for example.

The source electrode WS and drain electrode WD of the switching element SW are arranged on the first interlayer insulating film 22. The source electrode WS and drain electrode WD are in contact with the semiconductor layer SC through a contact hole which penetrates the gate insulating film 21 and first interlayer insulating film 22. Moreover, the source line S is also arranged on the first interlayer insulating film 22 and is formed of the same material as the source electrode WS. The gate electrodes WG, source electrode WS and drain electrode WD are formed of an electric conductive material with light blocking characteristics (or with characteristics hardly penetrating light), such as molybdenum, aluminum, tungsten, titanium, etc.

The source electrode WS, drain electrode WD and source line S are covered with the second interlayer insulating film 23. Moreover, the second interlayer insulating film 23 is arranged also on the first interlayer insulating film 22. The second interlayer insulating film 23 is formed of various resin materials, such as ultraviolet curing type resin and heat hardening type resin.

The capacitance line C or the counter electrode CE is arranged on the second interlayer insulating film 23. The capacitance line C or the counter electrode CE is covered with a third interlayer insulating film 24. Moreover, the third interlayer insulating film 24 is arranged also on the second interlayer insulating film 23. The third interlayer insulating film 24 is formed of an inorganic system material or resin material as mentioned-above.

The pixel electrode PE is arranged on the third interlayer insulating film 24. The pixel electrode PE is connected with the drain electrode WD through a contact hole which penetrates the second interlayer insulating film 23 and third interlayer insulating film 24. The slit PSL is formed in the pixel electrode PE. The slit PSL of the pixel electrode PE is formed, for example, in a 5-6 μm pitch.

The capacitance line C, counter electrode CE, and pixel electrode PE are formed of transmissive electric conductive materials, for example, Indium Tin Oxide (ITO), Indium Zinc Oxide (IZO), etc. The pixel electrode PE and the counter electrode CE which face each other through the third interlayer insulating film 24 form retention capacitance Cs. The pixel electrode PE is covered with a first alignment film 25. The first alignment film 25 is arranged on the surface which touches the liquid crystal layer LQ in the array substrate AR.

On the other hand, the counter substrate CT is formed using a second insulating substrate 30 with light transmissive characteristics such as a glass substrate. The counter substrate CT includes a first light shielding layer 51 and a color filter layer 32 on the internal surface (namely, surface which counters the liquid crystal layer LQ) of the second insulating substrate 30.

The first light shield layer 51 is arranged on the second insulating substrate 30. The first light shield layer 51 contains a demarcation portion (or called a black matrix) 511 which demarcates respective pixels PX. The demarcation portion 511 is arranged so that the demarcation portion 511 faces wiring portions, such as the gate line G and source line S, and switching element SW respectively formed on the array substrate AR. The demarcation portion 511 is formed in the shape of an approximately lattice.

The first light shield layer 51 is formed of resin material colored in black in which carbon black is distributed or metal material with light blocking characteristics, such as chromium (Cr). Moreover, the first light shield layer 51 has conductivity (in this case, the range is very wide from several Ω/cm² to more than 10¹² Ω/cm² that is an antistatic level).

More specifically, the color filter layer 32 is arranged on the second insulating substrate 30. The color filter layer 32 is arranged at a region surrounded by the demarcation portion 511, and specifically, the portion of the color filter layer 32 may overlap with the demarcation portion 511. The color filter layer 32 is formed of resin material colored in different colors, for example, three primary colors of red, blue and green.

In the liquid crystal display panel LPN using the lateral electric field mode as mentioned-above, it is desirable for the surface of the counter substrate CT which touches the liquid crystal layer LQ to be flat, and the counter substrate CT is further equipped with an overcoat layer 33 to make unevenness of the surface of the first light shield layer 51 and the color filter layer 32 flat. In the illustrated example, the overcoat layer 33 is arranged on the first light shield layer 51 and the color filter layer 32. The overcoat layer 33 is formed of resin material with light transmissivity. The overcoat layer 33 is covered with a second alignment film 34. The second alignment film 34 is arranged on the surface of the counter substrate CT, which touches the liquid crystal layer LQ. The first alignment film 25 and second alignment film 34 are formed, for example, with polyimide.

The array substrate AR and counter substrate CT are arranged so that the respective first alignment film 25 and second alignment film 34 may face each other. At this time, between the array substrate AR and counter substrate CT, a spacer (for example, pillar-shaped spacer integrally formed on one of the substrates by resin material) which is not illustrated is arranged, and thereby, a predetermined cell gap is formed. The array substrate AR and counter substrate CT are attached together by a seal element while a predetermined cell gap is formed.

The liquid crystal layer LQ is formed of liquid crystal material injected into the cell gap formed between the first alignment film 25 in the array substrate AR and second alignment film 34 in the counter substrate CT. The cell gap between the array substrate AR and counter substrate CT, that is, the layer thickness of the liquid crystal layer LQ between the first alignment film 25 and second alignment film 34 is 3 μm, for example.

A first polarizing plate PL1 is arranged at one external surface of the liquid crystal display panel LPN, that is, the external surface of the first insulating substrate 20 which constitutes the array substrate AR. Moreover, a shield element SE with light transmissivity is arranged on the other external surface of the liquid crystal display panel LPN, that is, the external surface of the second insulating substrate 30 which constitutes the counter substrate CT, and a second polarizing plate PL2 is further arranged on the second substrate 30 through the shield element SE.

The shield element SE may be a shield electrode formed of the electric conductive material with light transmissivity, such as ITO, or may be a conductive paste for attaching the second polarizing plate PL2 on the external surface of the second insulating substrate 30. Although illustration is omitted, the shield element SE is electrically connected to a shield wiring formed on the array substrate AR through an electric conductive element. The shield wiring is grounded, for example. The shield element SE shields unnecessary electric influence, such as static electricity from outside when driving the liquid crystal molecule. That is, it is possible to suppress the penetration of undesired electric field into the liquid crystal layer LQ by arranging the shield element SE.

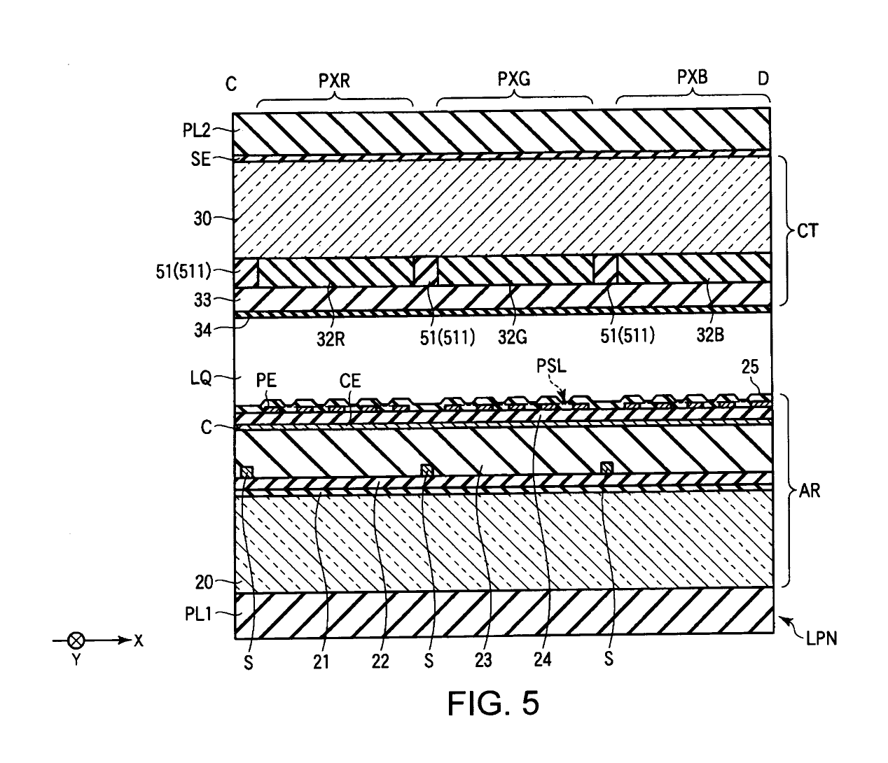

FIG. 5 is a cross-sectional view schematically showing a structure of three pixels of the liquid crystal panel shown in FIG. 3 taken along line C-D. Here, the same or like reference numerals designate the same or corresponding portions of the structure explained with reference to FIG. 4, and detailed explanation is omitted. Here, explanation is made about the case where three pixel PXs shown in FIG. 3 are red pixel PXR, green pixel PXG, and blue pixel PXB in order from left-hand side.

Each source line S is arranged on the first interlayer insulating film 22. The source line S is covered with the second interlayer insulating film 23. The source line S is located between a pair of adjoining pixels PX in the X direction in the array substrate AR. The demarcation portion 511 of the first light shield layer 51 formed on the counter substrate CT is located above the source line S.

The capacitance line C containing the counter electrode CE is arranged on the second interlayer insulating film 23. On the third interlayer insulating film 24 covering the capacitance line C, the pixel electrode PE faces the counter electrode portion CE in the capacitance line C.

The counter substrate CT includes a red color filter layer 32R, a green color filter layer 32G, and a blue color filter layer 32B as a color filter layer 32. The color filter layer 32R is arranged corresponding to the red pixel PXR. The color filter layer 32G is arranged corresponding to the green pixel PXG. The color filter layer 32B is arranged corresponding to the blue pixel PXB. The demarcation portion 511 of the first light shield layer 51 is arranged between the red pixel PXR and the green pixel, between the green pixel PXG and the blue pixel, between the red pixel PXR and the blue pixel PXB respectively although not illustrated. The demarcation portion 511 demarcates and shields light between the adjoining pixels PX.

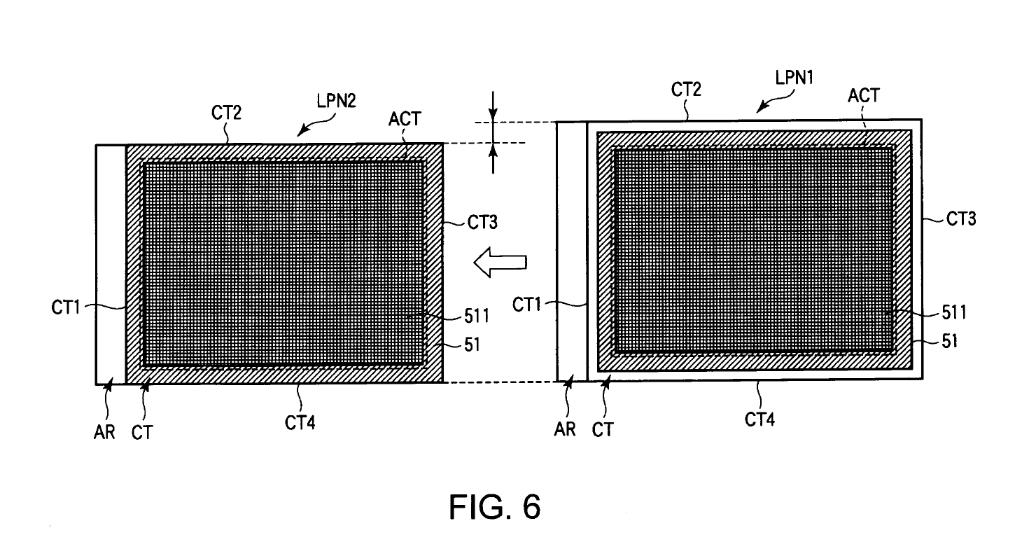

FIG. 6 is a view schematically showing a main portion of the liquid crystal display panel LPN1 in which the first light shield layer 51 formed on the counter substrate CT does not extend up to the end of the substrate, and a main portion of the liquid crystal display panel LPN2 in which the first light shield layer 51 extends up to the end of the substrate.

In the liquid crystal panel LPN1, the first light shield layer 51 is formed inside any of the first side CT1, second side CT2, third side CT3, and fourth side CT4, that is, arranged apart from the sides CT1 to CT4 on the counter substrate CT. On the other hand, in the liquid crystal panel LPN2, the first light shield layer 51 extends up to the first side CT1, second side CT2, third side CT3, and fourth side CT4 on the counter substrate CT. Namely, in the liquid crystal panel LPN2, the first light shield layer 51 is exposed at the substrate end of the counter substrate CT.

As illustrated, when the liquid crystal panel LPN1 is compared with the liquid crystal panel LPN2, the latter liquid crystal panel LPN2 is more advantageous for miniaturization (especially for narrow frame). Moreover, in various electronic devices, such as a display device and a portable device adopting the liquid crystal display panel LPN2, the miniaturization and improvement of appearance (design nature) are expectable.

However, in the liquid crystal panel LPN2, since the first light shield layer 51 has electric conductivity as mentioned-above, when a human finger or a module component of an electronic device contacts with the substrate end, electric charge flows into the exposed first light shield layer 51 or flows out to outside. Since the exposed first light shield layer 51 is electrically connected with the demarcation portion 511 arranged in the active area ACT, there is a possibility that distribution of an uneven electric charge may be formed in the active area ACT due to the charge flow at the end portion of the substrate. Therefore, even if the shield element SE is provided and the shield element SE shields unnecessary electric field penetrating into the active area ACT, there is a possibility of having a bad influence on display quality due to the uneven electric charge distribution in the active area ACT.

When human's finger, etc., contacts with the substrate end, more specifically, display unevenness or fluctuation of flicker arises. When fluctuation of flicker has arisen especially, it is necessary to adjust the flicker by adjusting the potential of the capacitance line C. However, when performing the flicker adjustment, miss-adjustment occurs and there is a possibility that display quality may be lowered.

In addition, there is a possibility that the above-mentioned problem may also occur, when a conductive foreign substance adheres to the substrate end, when an electrically conductive element for electrically connecting the shield element arranged at the external surface of the counter substrate CT with a shield wiring formed on the array substrate AR contacts with the first light shield layer 51 at the substrate end although not illustrated, and further, when short circuit is formed between the conductive element and the first light shield layer 51 by the conductive foreign substance adhered between the electric conductive element and the substrate end.

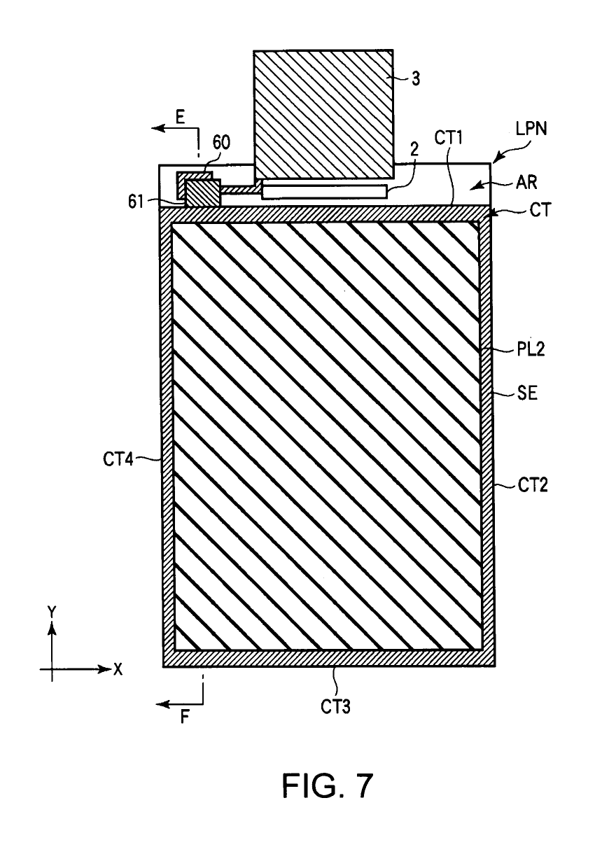

FIG. 7 is a plan view schematically showing a liquid crystal display panel LPN according to the embodiment looking from the counter substrate CT.

The driving IC chip 2 and the flexible wiring substrate 3 are connected to the array substrate AR. Moreover, a shield wiring 60 is formed in the array substrate AR. For example, the shield wiring 60 is electrically connected with the flexible wiring substrate 3 and is grounded.

A shield element SE is formed on the counter substrate CT. In the illustrated example, the shield element SE extends to the first side CT1, second side CT2, third side CT3, and fourth side CT4 of the counter substrate CT respectively. The shield element SE is electrically connected with the shield wiring 60 through an electric conductive element 61, such as a conductive tape and conductive paste near the first side CT1. The second polarizing plate PL2 is arranged on the shield element SE.

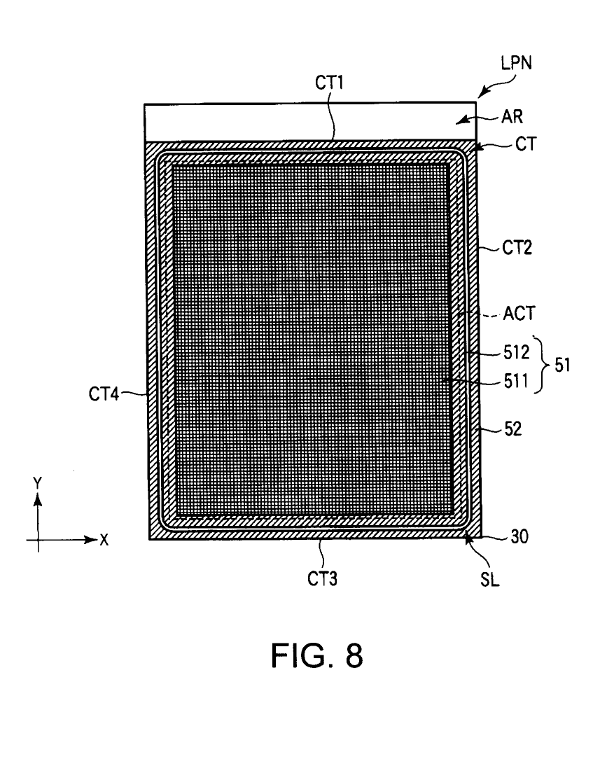

FIG. 8 is a plan view schematically showing an example of a first light shield layer and a second light shield layer applicable to the liquid crystal display panel shown in FIG. 7.

A first light shield layer 51 and a second light shield layer 52 formed on the counter substrate CT facing the array substrate AR are electrically insulated mutually. That is, the first light shield layer 51 includes the demarcation portion 511 and a frame portion 512 connected with the demarcation portion 511. Namely, the demarcation portion 511 and the frame portion 512 are electrically connected. The demarcation portion 511 is arranged in an area corresponding to the active area ACT. The demarcation portion 511 extends in the X direction and Y direction and is formed in the shape of a lattice. The frame portion 512 is connected with each termination portion of the demarcation portion 511. The frame portion 512 is arranged along the periphery of the active area ACT and is formed in the shape of a frame. The frame portion 512 is formed inside the first side CT1, second side CT2, third side CT3, and fourth side CT4 of the counter substrate CT. That is, the frame portion 512 is formed apart from the respective substrate ends of the second insulating substrate 30 which constitutes the counter substrate CT.

On the other hand, the second light shield layer 52 is arranged outside the first light shield layer 51 apart from the first light shield layer 51. That is, the second light shield layer 52 is not arranged in the active area ACT. In the illustrated example, the second light shield layer 52 is formed in the shape of a frame in the outside of the first light shield layer 51 extending up to the first side CT1, second side CT2, third side CT3, and fourth side CT4 on the counter substrate CT. That is, the second light shield layer 52 extends up to the substrate ends of the second insulating substrate 30 which constitutes the counter substrate CT. A loop-like slit SL is formed between the first light shield layer 51 and the second light shield layer 52. The width of the slit SL is set to a sufficient distance to insulate electrically the first light shield layer 51 and the second light shield layer 52. For example, the distance is about 10 μm.

The second light shield layer 52 is formed of resin material in which carbon black, etc., is distributed and is colored in black, or metal material such as chrome with light blocking characteristics like the first light shield layer 51. Although the first and second light shield layers 51 and 52 may be formed of different materials respectively with light blocking characteristics, it is desirable to form the first and second light shield layers 51 and 52 using the same material with light blocking characteristics and one common photolithography process to reduce the number of manufacturing processes and to use the material effectively. When the first light shield layer 51 and second light shield layer 52 are simultaneously formed, each film thickness is substantially the same.

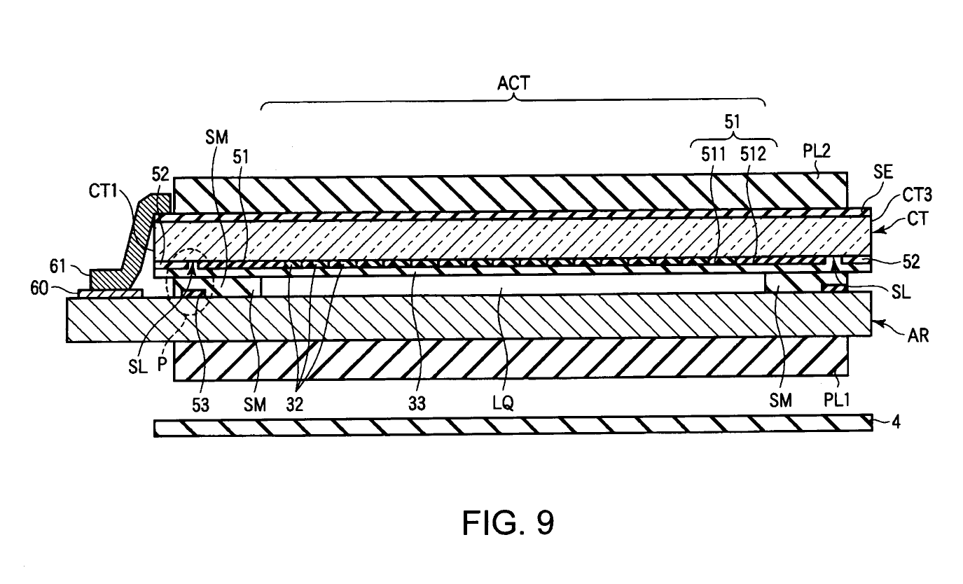

FIG. 9 is a cross-sectional view schematically showing the liquid crystal display panel LPN shown in FIG. 7 taken along line E-F. Only the main portion necessary for explanation is illustrated in FIG. 9.

That is, the array substrate AR and the counter substrate CT to constitute the liquid crystal display panel LPN are attached together by a seal element SM. The liquid crystal layer LQ is held between the array substrate AR and the counter substrate CT. While the first polarizing plate PL1 is arranged at the external surface of the array substrate AR, the second polarizing plate PL2 is arranged through the shield element SE at the external surface of the counter substrate CT, i.e., the external surface of the second insulating substrate 30. The first polarizing plate PL1 and second polarizing plate PL2 cover at least the active area ACT. The shield element SE is electrically connected with the shield wiring 60 through the electric conductive element 61.

In the counter substrate CT, the color filter layer 32, the first light shield layer 51 with the demarcation portion 511 and the frame portion 512, and the second light shield layer 52 are formed on the internal surface of the second insulating substrate 30 facing the array substrate AR. In the illustrated example, the second light shield layer 52 extends up to the substrate ends of the second insulating substrate 30, namely the first side CT1 and third side CT3. Between the first light shield layer 51 and the second light shield layer 52, a slit SL penetrated to the second insulating substrate 30 is formed. An overcoat layer 33 is arranged on the color filter layer 32, the first light shield layer 51 including the demarcation portion 511 and the frame portion 512, and the second light shield layer 52. In the illustrated example, the overcoat layer 33 also covers the slit SL.

The array substrate AR includes a third light shield layer 53 which shields light between the first light shield layer 51 and the second light shield layer s 52. That is, the third light shield layer 53 faces the slit SL formed between the first light shield layer 51 and second light shield layer 52. The third light shield layer 53 is formed of electric conductive material with light blocking characteristics to form the various wirings provided on the array substrate AR, for example, the same material as at least one of the gate line and source line. Therefore, the third light shield layer 53 prevents the light from being leaked through the slit SL.

According to this embodiment, the first light shield layer 51 containing the demarcation portion 511 arranged corresponding to the active area ACT is not exposed at the substrate end. Further, the second light shield layer 52 extending up to the substrate end is electrically isolated with the first light shield layer 51 arranged at the inner side of the second light shield layer 52. Therefore, even if the electric charge flows into and flows out from the second light shield layer 52 at the substrate end, distribution of uneven electric charge is hard to be formed in the active area ACT, and it becomes possible to reduce the influence on display quality. Accordingly, it becomes possible to provide a high quality liquid crystal display device which is compact and excellent in design nature.

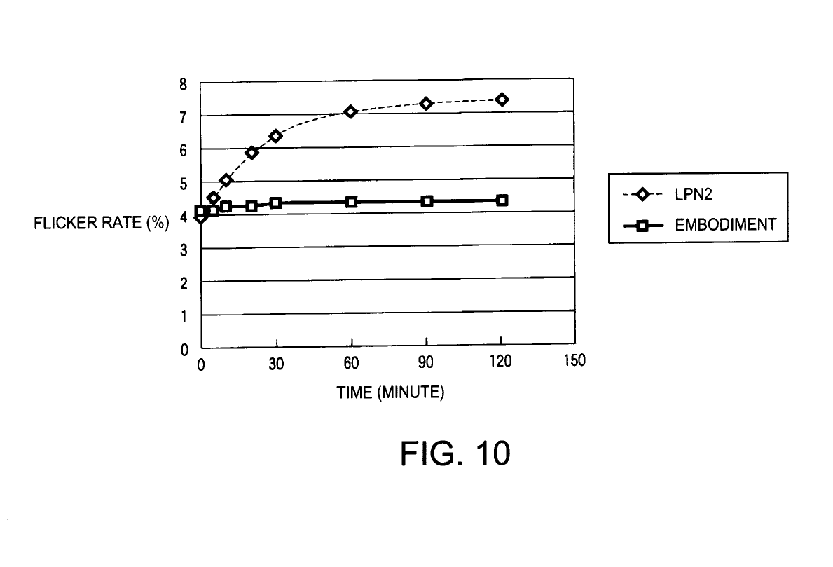

FIG. 10 is a view showing an example of measured result about a flicker in the liquid crystal display panel LPN2 and the liquid crystal display panel LPN according to this embodiment shown in FIG. 6. In the figure, a horizontal axis is time (minute) and a vertical axis is a flicker rate. Here, the flicker rate is defined by a VESA (Video Electronics Standards Association) standard. That is, the flicker rate is obtained using a wave-form produced by inputting a voltage signal converted from the light output of the liquid crystal device into an oscilloscope. The flicker rate is defined by a flicker amplitude (ratio of peak to peak value of AC ingredient and average luminosity of DC ingredient), that is, the following formula:

flicker rate=(flicker amplitude)/(average luminosity).

As illustrated, according to the liquid crystal display panel LPN of this embodiment, it is confirmed that variation of the flicker rate with passage of time can be more suppressed compared with the liquid crystal display panel LPN2 in which the first light shield layer 51 is exposed at the substrate end.

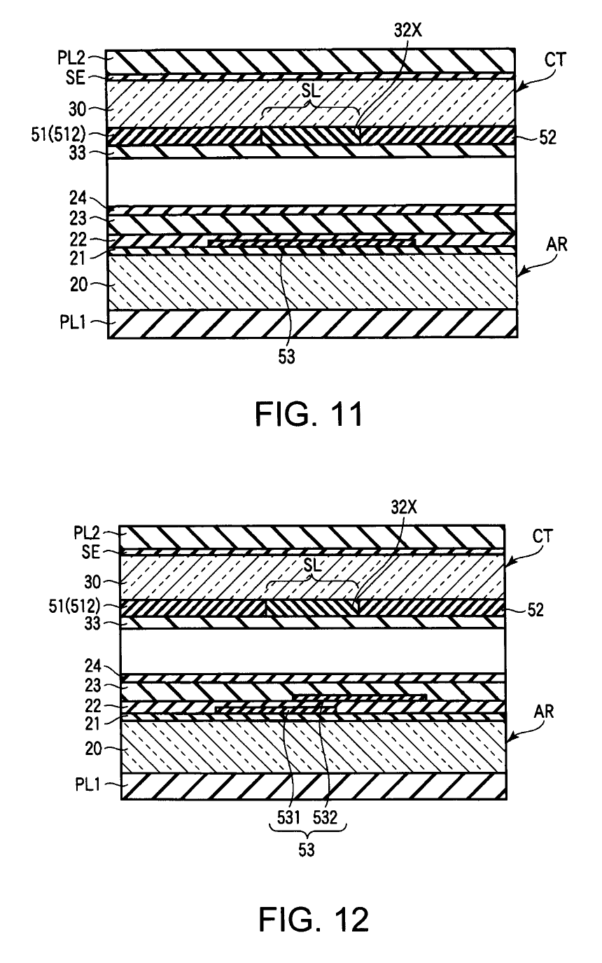

FIG. 11 is an enlarged view schematically showing a structure of a region P in the liquid crystal display panel shown in FIG. 9.

The array substrate AR is equipped with the third light shield layer 53 formed on the gate insulating film 21. The third light shield layer 53 is formed using the same material as the gate line which is not illustrated, i.e., the electric conductive material with light shielding characteristics. That is, the third light shield layer 53 is arranged in the same level layer as the gate line. The third light shield layer 53 is simultaneously formed with the gate line, etc., using a photolithography process. Thus, the third light shield layer 53 formed as above is covered with the first interlayer insulating film 22.

As for the width of the third light shield layer 53, it is desirable to be set larger than the width of the slit SL, i.e., the interval between the first light shield layer 51 and second light shield layer 52. At this time, it is desirable to arrange the third light shield layer 53 so that the third light shield layer 53 may face not only the slit but the frame portion 512 of the first light shield layer 51 and the second light shield layer 52. While being able to shield certainly the light from the back light penetrating to the slit from an oblique direction, and sufficient margin for misalignment of the array substrate AR and counter substrate CT is securable.

In the illustrated example, the counter substrate CT is equipped with a color filter layer 32X between the first light shield layer 51 and second light shield layer 52. That is, the slit SL is filled up with the color filter layer 32X. Although the film thickness of the color filter layer 32X is the same as that of the film thickness of the first light shield layer 51 and second light shield layer 52, and the surface of the color filter layer 32X forms the same plane as those of the first light shield layer 51 and the second light shield layer 52 here. However, the film thickness of the color filter layer 32X is not necessarily the same as that of the film thickness of the first light shield layer 51 and second light shield layer 52. Moreover, a portion of the color filter layer 32X may overlap with the first light shield layer 51 and second light shield layer 52. Anyway, as for the color filter layer 32X, it is desirable to arrange the color filter layer 32X so that slit SL may be buried by the color filter layer 32X without clearance. The color filter layer 32X, the first light shield layer 51, and the second light shield layer 52 are covered with an overcoat layer 33.

The color filter layer 32X is formed of the same material as one of the color filter layers arranged in the active area ACT. In the active area ACT, in the case the red color filter layer 32R, green color filter 32G, and blue color filter layer 32B as mentioned-above are arranged, the color filter layer 32X is formed of the same material as the blue color filter layer 32B, in which the color shows the lowest luminosity factor or the lowest transmissivity. As for the color filter layer 32B and the color filter layer 32X, it is desirable to form simultaneously and together using a photolithography process to reduce the number of manufacturing processes and to use the material effectively.

Thus, the level difference between the surface of the first and second light shield layers 51 and 52, and the surface (that is, bottom of the slit SL) of the second insulating substrate 30 can be reduced by arranging the color filter layer 32X in the slit SL. Moreover, even if, the shield by the third light shield layer 53 is insufficient, it becomes possible to control the optical leak from the slit SL by the color filter layer 32X.

In addition, in the example shown in FIG. 11, although the third light shield layer 53 is formed in the same level layer as the gate line using the same electric conductive material with light shielding characteristics as the gate line, the third light shield layer 53 may be formed in the same level layer as the source line using the same electric conductive material with the light shielding characteristics as the source line. In this case, the third light shield layer 53 is formed simultaneously with the source line using a photolithography process.

FIG. 12 is an enlarged view schematically showing another structure of the region P in the liquid crystal display panel shown in FIG. 9.

The illustrated example is different from the example shown in FIG. 11 in the point that the third light shield layer 53 arranged on the array substrate AR is formed by two-layer structure. That is, the third light shield layer 53 includes a first segment 531 formed on the gate insulating film 21 and a second segment 532 formed on the first interlayer insulating film 22.

The first segment 531 is formed in the same layer as gate line using the same electric conductive material with light shielding characteristics as the gate line. The first segment 531 is covered with the first interlayer insulating film 22. The second segment 532 is formed in the same layer as the source line using the same electric conductive material with light shielding characteristics as the source line. The second segment 532 is covered with the second interlayer insulating film 23.

In such structure, the respective width of the first segment 531 and the second segment 532 may not be set necessarily larger than the width of the slit. In the illustrated example, the first segment 531 is arranged so that the first segment 531 faces the slit SL, the first light shield layer 51 and the second segment 532, and the second segment 532 is arranged so that the second segment 532 faces the first segment 531, the slit SL and the second light shield layer 52. That is, a portion of the first segment 531 and a portion of the second segment 532 overlap each other through the first interlayer insulating film 22. In the above structure, the same effect as the example shown in FIG. 11 is acquired.

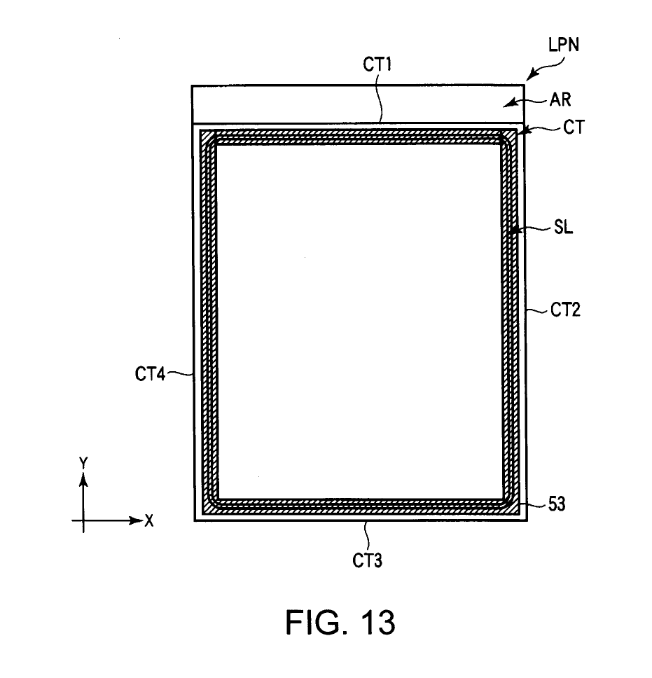

FIG. 13 is a plan view schematically showing an arrangement example of the third light shield layer facing the slit each other.

The third light shield layer 53 formed on the array substrate AR faces approximately whole of the slit SL formed in the counter substrate CT. In the illustrated example, the third light shield layer 53 is formed in the shape of a frame so as to face the slit SL formed in the shape of a loop. The third light shield layer 53 does not need to be formed in a single layer throughout. For example, the third light shield layer 53 may be formed of the first segment 531 shown in FIG. 12 for the portion which faces the slit SL formed along the second side CT2, third side CT3, and fourth side CT4 on the counter substrate CT, and the third light shield layer 53 may be formed of the second segment 532 shown in FIG. 12 for the portion facing the slit formed along the fourth end CT1.

Since the third light shield layer 53 is formed of electric conductive material, it is necessary to prevent short-circuit with various wirings of the array substrate AR. Therefore, when forming the third light shield layer 53 in the array substrate AR, which segment of the first segment 531 and the second segment 532 is applied is arbitrarily chosen so as to arrange an interlayer insulating film between the wirings and the third light shield layer 53 in the portion where the third light shield layer 53 cross with the wirings.

In addition, although the third light shield layer 53 may be floating electrically, the third light shield layer 53 may be a portion of wiring to which predetermined potential is supplied. For example, at least a portion of the third light shield layer 53 may be the common wiring Vcom shown in FIG. 2.

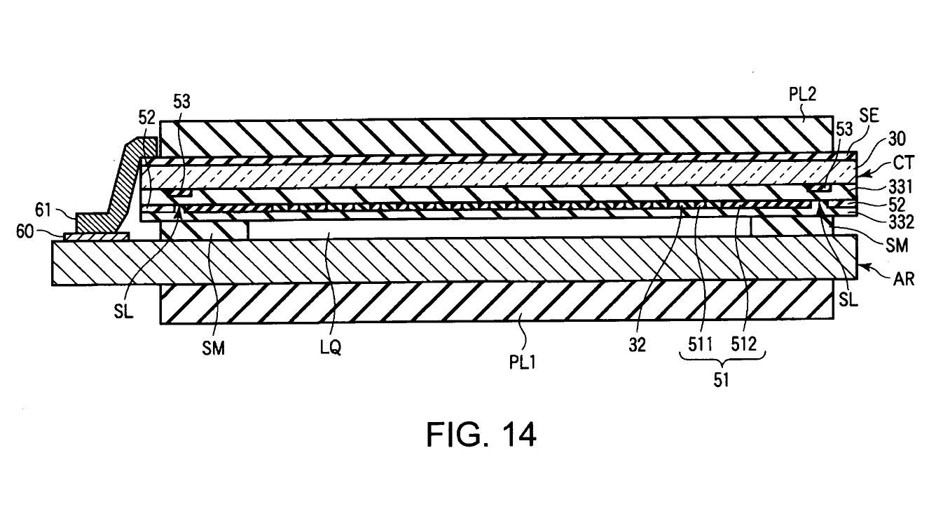

FIG. 14 is a cross-sectional view schematically showing other structure of the liquid crystal display panel shown in FIG. 7 taken along line E-F. The illustrated example is different from the example shown in FIG. 9 in the point that the counter substrate CT is equipped with the third light shield layer 53.

That is, in the counter substrate CT, the third light shield layer 53 is formed on an internal surface of the second insulating substrate 30 opposing to the array substrate AR. The third light shield layer 53 is formed inside each sides of the counter substrate CT and is not exposed at the substrate end of the second insulating substrate 30. The third light shield layer 53 is covered with the first overcoat layer 331.

The color filter layer 32, the first light shield layer 51 including the demarcation portion 511 and the frame portion 512, and the second light shield layer 52 are formed on the first overcoat layer 331 and are covered with a second overcoat layer 332. Moreover, the second overcoat layer 332 also covers the slit SL between the first light shield layer 51 and second light shield layer 52. The first overcoat layer 331 and second overcoat layer 332 are formed of the resin material with light transmissivity like the overcoat layer 33 as mentioned-above

In the example shown here, the first overcoat layer 331 corresponds to the interlayer insulating film arranged between the third light shield layer 53, and the first light shield layer 51 and the second light shield layer 52. The third light shield layer 53 is located right above the slit SL formed between the first light shield layer 51 and second light shield layer 52.

Also in the above structure, the same effect as the structure explained with reference to FIG. 9 is acquired. Moreover, since the third light shield layer 53 is formed on the counter substrate CT, the possibility that the third light shield layer 53 intersects with wirings is very low as compared with the example in which the third light shield layer 53 is formed on the array substrate AR as shown in FIG. 9. Therefore, the flexibility of a layout can be improved.

In addition, the first light shield layer 51 and second light shield layer 52 may be arranged between the second insulating substrate 30 and the first overcoat layer 331, and the third light shield layer 53 may be arranged between the first overcoat layer 331 and the second overcoat layer 332.

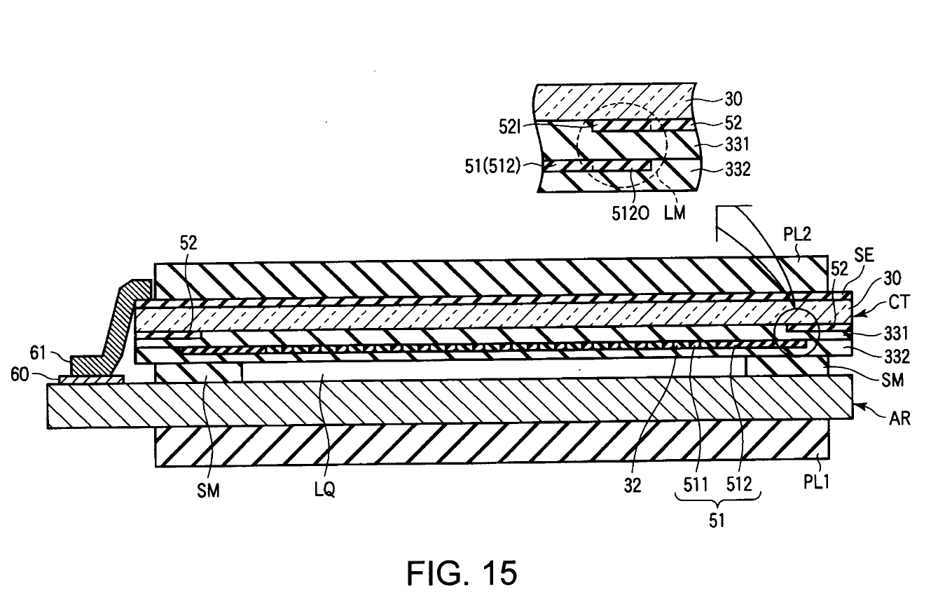

FIG. 15 is a cross-sectional view schematically showing other structure of the liquid crystal display panel LPN shown in FIG. 7 taken along line E-F.

The illustrated example is different in the point that the slit is not formed between the first light shield layer 51 and second light shield layer 52, and the third light shield layer is omitted compared with the example shown in FIG. 14.

That is, the second light shield layer 52 is formed on the internal surface of the second insulating substrate 30 in which the array substrate AR faces the counter substrate CT. The second light shield layer 52 extends up to each side of the counter substrate CT, and is exposed at the substrate end of the second insulating substrate 30. The second light shield layer 52 is covered with the first overcoat layer 331.

The color filter layer 32 and the first light shield layer 51 including the demarcation portion 511 and the frame portion 512 are formed on the first overcoat layer 331, and is covered with the second overcoat layer 332. In the example shown here, the first overcoat layer 331 corresponds to the interlayer insulating film arranged between the second light shield layer 52 and first light shield layer 51.

Although the frame portion 512 of the first light shield layer 51 is formed inside each side of the counter substrate CT as shown in the enlarged portion of the figure, an outer edge portion 5120 of the first light shield portion overlaps at least with an internal edge portion 521 of the second light shield layer 52 through the first overcoat layer 331. That is, the counter substrate CT has a stacked portion LM in which the outer edge portion 5120, the first overcoat layer 331, and the internal edge portion 521 are stacked in order.

According to the structure, in spite of having omitted the third light shield layer, the optical leak between the first light shield layers 51 and second light shield layer 52 electrically insulated each other can be prevented. Therefore, the same effect as the structure explained with reference to FIG. 9 is acquired.

In addition, the first light shield layer 51 may be arranged between the second insulating substrate 30 and the first overcoat layer 331, and the second light shield layer 52 may be arranged between the first overcoat layer 331 and the second overcoat layer 332.

In this embodiment as mentioned-above, although the first light shield layer 51 is in the floating state electrically, fixed potential may be impressed to the first light shield layer 51.

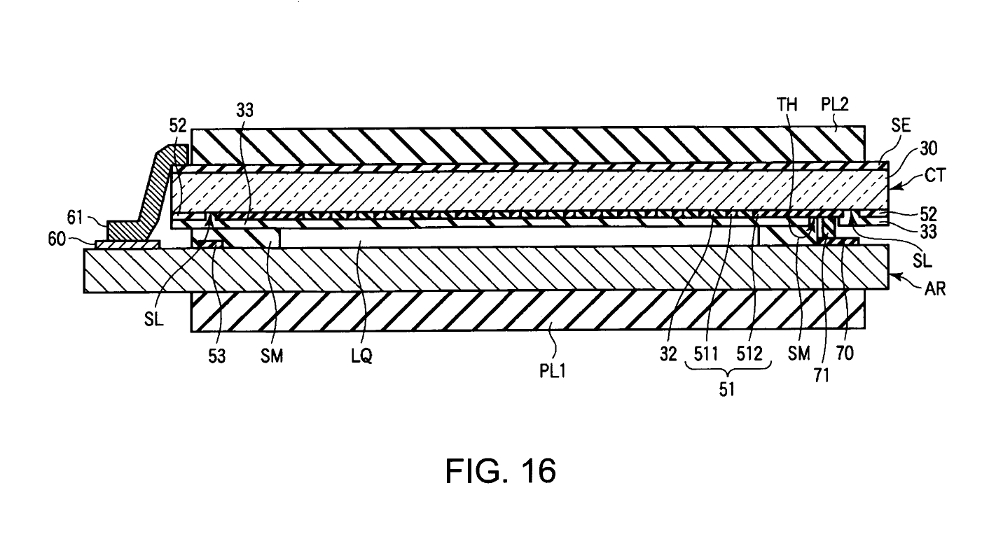

FIG. 16 is a cross-sectional view schematically showing an example of a structure to set the first light shield layer to a fixed potential.

The illustrated example is different from the example shown in FIG. 9 in the point that the array substrate AR includes a connection electrode 70, and further an electric conductive element 71 to electrically connect the first light shield layer 51 with the connection electrode 70.

That is, the connection electrode 70 faces the first light shield layer 51. Fixed potential is impressed to the connection electrode 70. The surface of the connection electrode 70 is exposed. On the other hand, a through hole TH penetrating up to the first light shield layer 51 is formed in the overcoat layer 33 which covers the first light shield layer 51. The through hole TH faces the connection electrode 70. The electric conductive element 71 is formed of conductive paste, etc., and contacts with the first light shield layer 51 through the through hole TH while the electric conductive element 71 contacts with the connection electrode 70, thereby the conductive element 71 electrically connects the first light shield layer 51 and connection electrode 70.

According to the above structure, it becomes possible to stabilize the operating state of the liquid crystal display panel LPN more in addition to achieving the same effect as the structure explained with reference to FIG. 9.

The above technology of impressing the fixed potential to the first light shield layer 51 can be applied not only to the example to form the third light shield layer 53 in the array substrate AR as shown in FIG. 9, but the example to form the third light shield layer 53 on the counter substrate CT as shown in FIG. 14, and the example to electrically isolate between the first light shield layer 51 and second light shield layer 52 while omitting the third light shield layer 53 as shown in FIG. 15.

In this embodiment as mentioned-above, the second light shield layer 52 does not need to be arranged along four sides of the counter substrate CT, although the second light shield layer 52 is formed in the shape of a frame in the outside of the first light shield layer 51. That is, in this embodiment, when the second light shield layer 52 extending up to the substrate end is arranged along at least one side of the counter substrate CT, the second light shield layer 52 and first light shield layer 51 are insulated electrically each other.

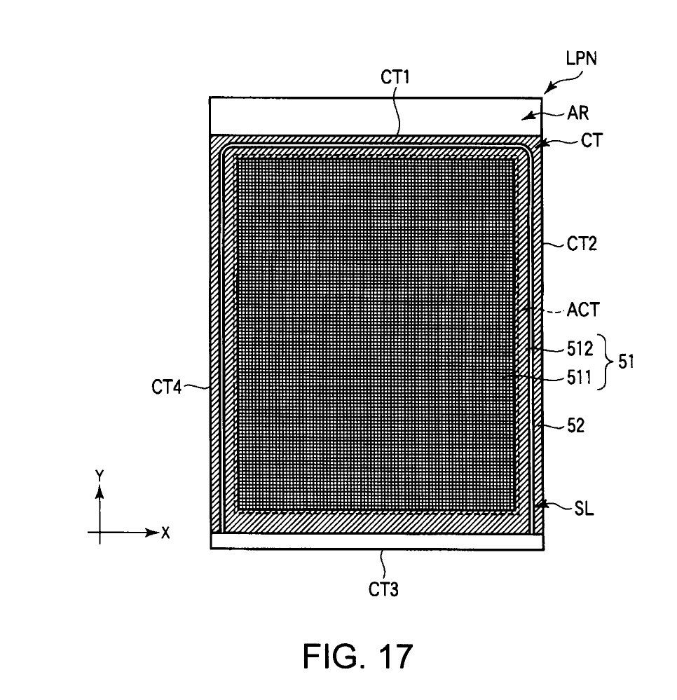

FIG. 17 is a plan view showing other example of the first light shield layer 51 and second light shield layer 52 applicable to the liquid crystal display panel LPN shown in FIG. 7.

The illustrated example is different from the structure shown in FIG. 8 in the point that the second light shield layer 52 along the third side CT3 of the counter substrate CT is omitted. That is, the first light shield layer 51 includes the demarcation portion 511 and the frame-like frame portion 512 while the second light shield layer 52 is apart from the first light shield layer 51, and extends up to the first side CT1, second side CT2, and fourth side CT4 on the counter substrate CT in the outside of the first light shield layer 51. That is, the second light shield layer does not exist between the third side CT3 of the counter substrate CT and the frame portion 512 of the first light shield layer 51. A U character-like slit SL in plane is formed between the first light shield layer 51 and second light shield layer 52 in the circumference of the first side CT1, second side CT2, and fourth side CT4 on the counter substrate CT

Also in the above structure, the same effect as the structure explained with reference to FIG. 9 is acquired.

Next, a case where the liquid crystal display device equipped with a touch-panel function in the inside of the liquid crystal display panel LPN is explained according to this embodiment.

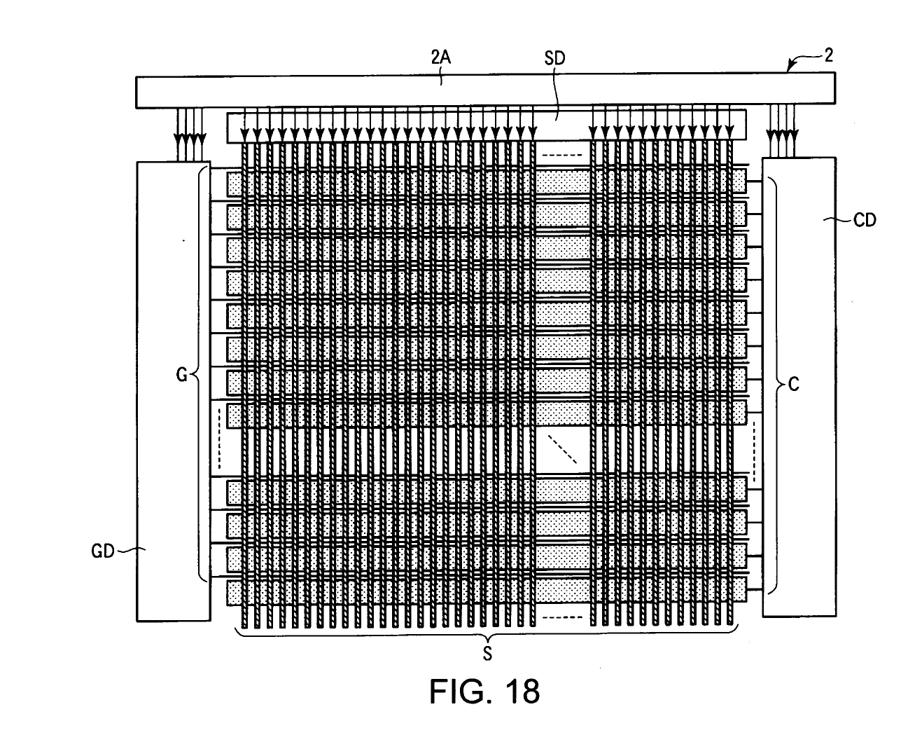

FIG. 18 is a figure for explaining the writing of the image signal in an image display mode.

The image signal write-in circuit 2A of the driving IC chip 2 outputs a control signal to each gate line G to set the switching element SW to the ON state by controlling the first driver circuit GD. Moreover, the image signal write-in circuit 2A outputs the image signal to each source line S by controlling the second driver circuit SD. The image signal outputted to the source line S is written in the pixel electrode PE through the conducted switching element SW. On the other hand, the image signal write-in circuit 2A controls the third driver circuit CD to supply a common voltage to each capacitance line C.

Thereby, the voltage corresponding to the image signal is impressed to the liquid crystal layer LQ between the pixel electrode PE and the counter electrode CE in the capacitance line C. In the liquid crystal layer LQ, the liquid crystal molecule aligns according to the impressed voltage. Consequently, a modulation rate to the light passing in the liquid crystal layer LQ changes. For this reason, the incident light to the liquid crystal display panel LPN from the back light 4 selectively passes in the polarizing plate PL2 depending on the voltage applied between the pixel electrode PE and counter electrodes CE. Thereby, the image corresponding to the image signal is displayed on the display surface.

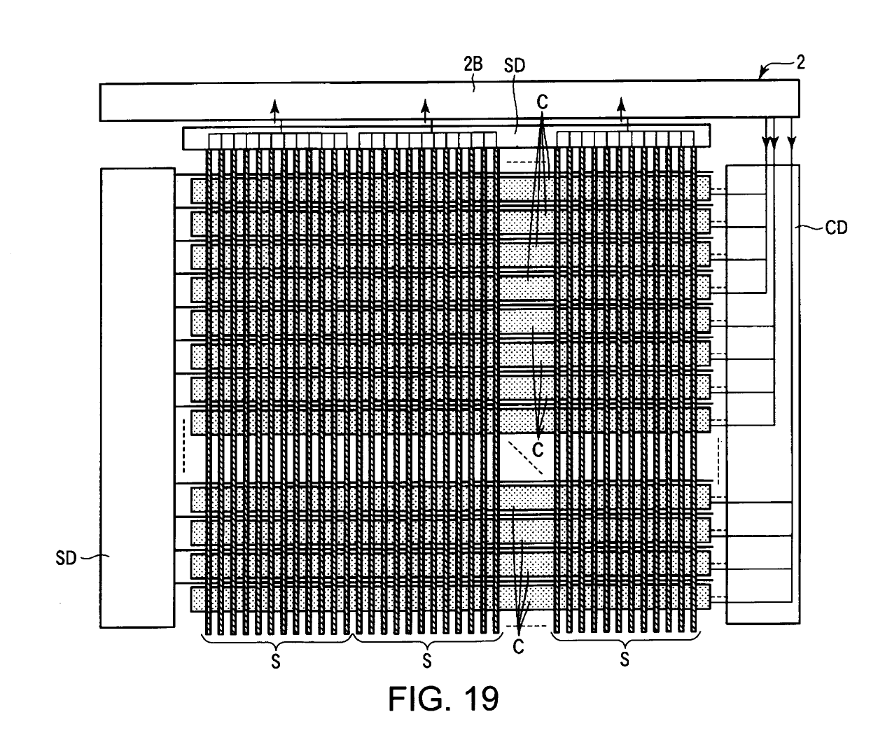

FIG. 19 is a block diagram for explaining the writing operation of the detection signal and the detection operation in a detection mode. In addition, the pixel electrode PE is in a floating state in the detection mode.

A detection circuit 2B of the driving IC chip 2 writes the detection signal in the capacitance line C by controlling the third driver circuit CD. Here, the detection signal is, for example, an alternate signal. At this time, the third driver circuit CD simultaneously writes the detection signal to the plurality of adjoining capacitance lines C, that is, four adjacent capacitance lines C in this embodiment. Namely, the capacitance lines C are divided into some groups to use the capacitance lines as the detection elements. The third driver circuit CD includes one or more switches connected to each capacitance line C and sequentially supplies the common voltage to the respective capacitance lines C in the display mode. On the other hand, the detection signal is written into the respective capacitance lines C by making the switches connected to the plurality of the capacitance lines C simultaneously ON state.

Furthermore, the detection circuit 2B pre-charges each source line S by controlling the second driver circuit SD. Since an alternate detection signal is written in the capacitance line C, the potential of the source line S changes. The detection circuit 2B reads the potential change of the source line S at this time. When an object approaches to or touches the detection plane, an electrostatic capacitance between the capacitance line C and source line S changes. A potential fluctuation of the source line S also changes with the change of the electrostatic capacitance. For this reason, in the detection circuit 2B, the change of the electrostatic capacitance between the capacitance line C and the source line S, namely, the approach or touch to the detection plane by an object, is detected by monitoring the change of the potential fluctuation or a current value of the source line S.

In this embodiment, the second driver circuit SD simultaneously reads the potential change or the current value change of two or more source lines S, specifically, twelve adjacent source lines S in the illustrated example. This is a way to make groups of the source lines S, and to use the source lines S as detection elements. The second driver circuit SD includes one or more switches connected to the respective capacitance lines C and writes the image signal into the respective source lines S by sequentially conducting the switches SW in the display mode. On the other hand, the potential change or the current value change is read after the source lines S are pre-charged by simultaneously making the switches connected to the respective source lines S conductive state in the detection mode.

In addition, the detection signal is written in the capacitance line C, and the potential change in the source line S accompanied with the change of the electrostatic capacitance is read in the illustrated example. However, the detection signal may be written in the source line S, and the potential change in the capacitance line C accompanied with the change of electrostatic capacitance may be read. Moreover, in the detection mode, the number of grouped capacitance lines and source lines S is set according to required detection sensitivity.

Moreover, in the detection mode, the grouping of the capacitance lines C and the source lines S which are detection elements, may be changed for every timing. For example, the accuracy of the detection is improvable by grouping the adjacent two or more detection elements (the capacitance lines C and source lines S) at the first timing, and by changing the combination of the grouping at the second timing. The detection elements may be grouped in various ways, for example, by respectively using half number of the detection elements in one group and adjacent group at the first timing, or by using every other detection element or every two detection elements. Such combination for the grouping can be arbitrarily changed by the combination of the switches connected to the detection elements.

Thus, in the liquid crystal display panel LPN equipped with the touch-panel function, when the capacitance line C and source line S are used as electric capacitance sensing electrodes, and the first light shield layer 51 is exposed at the substrate end, the detected capacitance value changes due to the flow of the electro static charges at the substrate end. Accordingly, the detection sensitivity as the touch panel is remarkably lowered, and the electric capacitance sensing electrodes receive an external noise. Consequently, the sensing ability is lowered.

On the other hand, according to this embodiment, since the second light shield layer 52 exposed at the substrate end is electrically isolated with the first light shield layer 51 located in the active area, and the first light shield layer 51 is set to a floating state. Accordingly, it is possible to perform a stable sensing operation.

In this embodiment, although the liquid crystal display device uses the FFS mode, other lateral electric mode such as IPS mode can be used in place of the FFS mode without being limited to the FFS mode.

While certain embodiments have been described, these embodiments have been presented by way of embodiment only, and are not intended to limit the scope of the inventions. In practice, the structural elements can be modified without departing from the spirit of the invention. Various embodiments can be made by properly combining the structural elements disclosed in the embodiments. For embodiment, some structural elements may be omitted from all the structural elements disclosed in the embodiments. Furthermore, the structural elements in different embodiments may properly be combined. The accompanying claims and their equivalents are intended to cover such forms or modifications as would fall with the scope and spirit of the inventions.

What is claimed is:

1. A liquid crystal display device, comprising:
a first substrate including a first insulating substrate, and a pixel electrode and a counter electrode formed on the first insulating substrate;
a second substrate including;
a second insulating substrate,
a first light shield layer formed on a surface of the second insulating substrate apart from an end of the second insulating substrate opposing to the first substrate, and having a frame portion in a frame shape, and
a second light shield layer arranged adjoining the first light shield layer and extending up to the end of the second insulating substrate opposing to the first substrate,
a liquid crystal layer held between the first and second substrates; and
a third light shield layer to shield light between the first light shield layer and second light shield layer.

2. The liquid crystal display device according to claim 1, wherein the third light shield layer is formed on the first substrate.

3. The liquid crystal display device according to claim 1, wherein the third light shield layer is formed on the second substrate.

4. The liquid crystal display device according to claim 1, wherein the first substrate further includes a gate line, a source line, an interlayer insulating film arranged between the gate line and source line, and the third light shield layer is formed of the same material as one of the gate line and source line.

5. The liquid crystal display device according to claim 3, wherein the second substrate further includes an interlayer insulating film arranged between the first and second light shield layers, and the third light shield layer.

6. The liquid crystal display device according to claim 1, wherein the second substrate further includes a color filter layer arranged between the first light shield layer and second light shield layer.

7. The liquid crystal display device according to claim 1, wherein the width of the third light shield layer is set larger than a gap between the first light shield layer and second light shield layer.

8. The liquid crystal display device according to claim 1, further comprising a connection electrode formed on the first substrate and receiving a fixed voltage, and a electrically conductive element to connect the first light shield layer with the connection electrode.

9. The liquid crystal display device according to claim 1, wherein the second light shield layer is arranged along with at least one of the sides of the second substrate.

10. The liquid crystal display device according to claim 1, wherein the first substrate includes a capacitance line containing a counter electrode, a signal line extending so as to cross with the capacitance line, an interlayer insulating film arranged between the capacitance line and signal line, and a detection circuit for detecting change of static capacitance between the capacitance line and the signal line.

11. The liquid crystal display device according to claim 1, further comprising a shield element with transmissivity formed on an external surface of the second insulating substrate and a polarizing plate arranged on the second insulating substrate through the shield element.

12. A liquid crystal display device, comprising:
a first substrate including a first insulating substrate, and a pixel electrode and a counter electrode formed on the first insulating substrate;
a second substrate including;
a second insulating substrate,
a first light shield layer formed on a surface of the second insulating substrate apart from an end of the second insulating substrate opposing to the first substrate, and having a frame portion in a frame shape,
a second light shield layer arranged adjoining the first light shield layer and extending up to the end of the second insulating substrate opposing to the first substrate,
an interlayer insulating film arranged between the first light shield layer and second light shield layer, and
a stacked portion where the frame portion of the first light shield layer, the second light shield layer and the interlayer insulating film are stacked,
a liquid crystal layer held between the first and second substrates.

13. The liquid crystal display device according to claim 12, further comprising a connection electrode formed on the first substrate and receiving a fixed voltage, and a electrically conductive element to connect the first light shield layer with the connection electrode.

14. The liquid crystal display device according to claim 12, wherein the second light shield layer is arranged along with at least one of the sides of the second substrate.

15. The liquid crystal display device according to claim 12, wherein the first substrate includes a capacitance line containing a counter electrode, a signal line extending so as to cross with the capacitance line, an interlayer insulating film arranged between the capacitance line and signal line, and a detection circuit for detecting change of static capacitance between the capacitance line and the signal line.

16. The liquid crystal display device according to claim 12, further comprising a shield element with transmissivity formed on an external surface of the second insulating substrate and a polarizing plate arranged on the second insulating substrate through the shield element.

17. A liquid crystal display device including an active area to display an image, comprising:
a first substrate including a first rectangular insulating substrate, and a pixel electrode and a counter electrode formed in the active area on the first insulating substrate;
a second substrate including;
a second rectangular insulating substrate,
a first light shield layer formed on a surface of the second insulating substrate opposing to the first substrate, and having a frame portion in a frame shape wherein the frame portion defines the active area, and
a second light shield layer arranged adjoining the first light shield layer and extending up to the end of the second insulating substrate,
a slit formed between the first light shield layer and second light shield layer;
a liquid crystal layer held between the first and second substrates; and
a third light shield layer facing the slit to shield light between the first light shield layer and the second light shield layer.

18. The liquid crystal display device according to claim 17, wherein the third light shield layer is formed on the first substrate.

19. The liquid crystal display device according to claim 17, wherein the third light shield layer is formed on the second substrate.

20. The liquid crystal display device according to claim 17, wherein the slit penetrates up to the second insulating substrate.
